(19) United States
(12) Patent Application Publication
(10) Pub. No.: US 2020/0193799 A1
(43) Pub. Date: Jun. 18, 2020

(54) Network enabled home automation wired sensor system

(71) Applicant: Konnected, Inc., Cheyenne, WY (US)

(72) Inventor: Nathaniel Clark, Longwood, FL (US)

(73) Assignee: Konnected, Inc., Cheyenne, WY (US)

(21) Appl. No.: 16/350,397

(22) Filed: Nov. 8, 2018

Related U.S. Application Data
(60) Provisional application No. 62/584,320, filed on Nov. 10, 2017.

(51) Int. Cl. G08B 25/08; G08B 25/14; G08B 25/10

(52) U.S. Cl. CPC G08B 25/085; G08B 25/10; G08B 25/14

(57) ABSTRACT

An apparatus for retrofitting a hard-wired building alarm system, the apparatus comprising: a processor comprising a communications module and a translation module; a power supply connected to a plurality of power out terminals, wherein a power out terminal is connected to powered building security device using the hard-wired building alarm system wiring; and a plurality of input/output terminals, wherein an input/output terminal is connected to a building security sensor using the hard-wired building alarm system wiring; wherein the processor is configured to: receive sensor data input from an input/output terminal; translate the sensor data input into home automation output; and transmit the home automation output to a home automation server using the communication module; wherein the processor is further configured to: receive an actuator instruction from the home automation server via the communication module; translate the actuator instruction into an electrical current on an input/output terminal.

### RELATED APPLICATION DATA

This application claims priority to provisional application 62/584,320 filed on Nov. 10, 2017, entitled “WI-FI ENABLED ALARM SYSTEM PANEL FOR WIRED SECURITY SYSTEM,” the contents of which are fully incorporated by reference herein for all purposes.

### TECHNICAL FIELD

This disclosure relates to security systems and more particularly a networked enabled alarm panel system for existing wired security systems.

### BACKGROUND OF THE INVENTION

Conventional alarm system panels, popular since around the 1980s, are based on logic boards that are programmed locally. They use hardwiring to any detector on the premises. If a conventional alarm system is connected to a monitoring service, the connection typically uses a telephone line. Thus, signals are received at the local logic board within the facility to be protected. Those signals may then be communicated out of the facility to be protected by using the telephone connection provided in the security system logic board.

Some companies have built technology solutions that connect to some models of alarm system panels to provide internet or cellular data connectivity, but these devices still relied on the local logic and sensor supervision of the alarm system panel and were restrictive in the types of servers and devices they integrate with.

Newer alarm systems may use only wireless features however, these need to replace the older systems as a whole as the new and old alarm systems are not compatible. Generally speaking, known wireless alarms need to be programmed to communicate with wireless sensors and thus, an entire system needs to be replaced.

A trend has developed for additional home automation capabilities. Modern consumer products and services in the home automation or Internet of Things (IoT) space have combined home security with other home automation tasks, such as automating lights and audible chimes based on feedback from door, window, or motion sensors located throughout the home. These systems require new sensors (generally wireless) that are compatible with such home automation systems.

There is a need to improve older alarm panel systems to interconnect with modern home automation systems, without need to replace the entire existing alarm panel system.

### SUMMARY OF THE INVENTION

According to one embodiment, this disclosure provides an apparatus for integrating a wired building security system with a home automation system.

The disclosed apparatus has several important advantages. An issue with home automation systems is acquiring sensors and devices for the components throughout a building that could be useful for home automation purposes. Legacy building security systems have copper wiring throughout used to connect a central panel with sensors throughtout the structure. An apparatus as disclosed herein enables the use of home automation system without need to acquire significant and costly sensors by capitalizing on the pre-existing sensors throughout a building and enabling those sensors to communicate with home automation systems.

Various embodiments of the present disclosure may have none, some, or all of these advantages. Other technical advantages of the present disclosure may also be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a schematic drawing of one embodiment of the present disclosure.

FIG. 2 is a schematic drawing of a processor in accordance with a preferred embodiment of the present disclosure.

Similar reference numerals refer to similar parts or steps throughout the several views of the drawings.

### DETAILED DESCRIPTION OF THE EMBODIMENTS

The present disclosure relates to an apparatus for integrating a wired building security system with a home automation system. Wired building security systems have sensors and actuators placed throughout the structure for gathering and reporting information. These sensors may be window sensors, door sensors, glass-break sensors, or other sensors for detecting openings or closings of access points to the buildings. The actuators may be sirens or strobe lights, or other components used for indicating information, such as sounding an alarm upon a security breach.

Some sensors may require the use of power, while other sensors may be unpowered. Some sensors may require power at all times, such as a motion detector. Other sensors may require power only at certain times, such as an alarm.

Currently, home automation systems do not integrate with legacy home security systems. Thus, if you'd like an alarm connected to a home automation system, you can not reuse the existing alarm in your building that may already be connected to your home security system.

The sensors and actuators in a legacy home automation system are connected to a centralized panel within the structure. These sensors and actuators are typically connected to the centralized panel via copper wiring run throughout the structure. In a preferred embodiment, the present disclosure is used to replace logic components within the centralized panel.

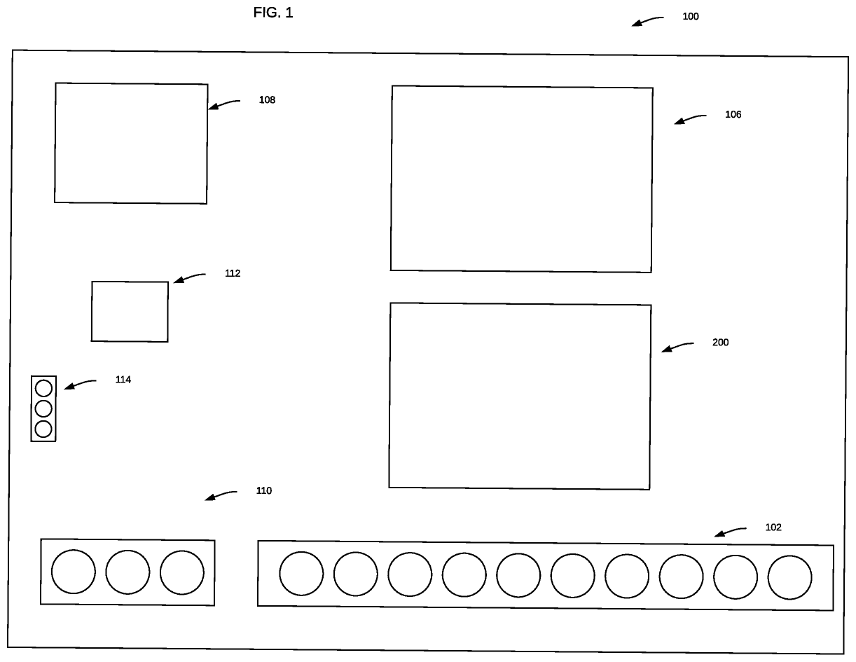

One embodiment of the present disclosure is shown in FIG. 1. An apparatus 100 comprises a plurality of input/output terminals 102, a processor 200, a communication module 106, a power supply 108, and a plurality of power out terminals 110. In a preferred embodiment, the apparatus 100 is preferably a logic board shaped and configured to include each of the other components. The apparatus 100 is preferably shaped so that it may fit in or around the centralized panel in the legacy home security system.

The plurality of input/output terminals 102 are used to connect to existing sensors throughout the building. In a preferred embodiment, the wiring is disconnected from the centralized alarm panel and reconnected to corresponding sensors in the plurality of input/output terminals 102. Similarly, powered devices throughout the structure are preferably disconnected from the centralized alarm panel and connected to corresponding power out terminals 110. There may also be a switch 112 to enable the apparatus to switch power on or off for different powered items.

The apparatus 100 may also include one or more indicators 114. These indicators may be one or more LEDs to provide status information to an operator. For example, there may be a red alarm LED to indicate an error condition, or a green LED to indicate power is being received via the power supply 108.

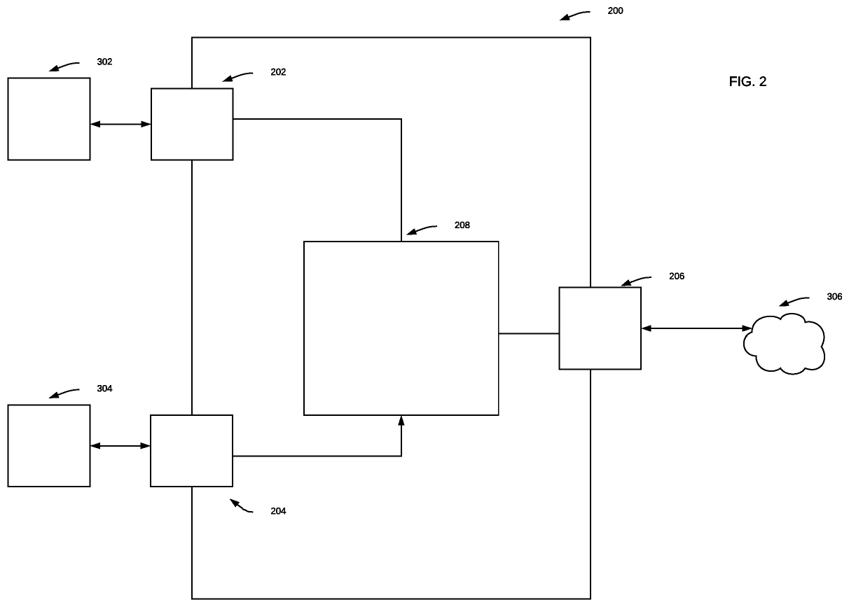

The processor 200 is shown in additional detail in FIG. 2. As depicted, in a preferred embodiment, the processor 200 includes a translation module 208, a sensor interface 200, an actuator interface 204, and home automation application programming interface (“API”) 208. The translation module 208 is computing logic and associated computing components implementing the computing logic.

The translation module 208 receives input from the sensors via the sensor interface 200. For instance, when a door sensor recognizes that the corresponding door is open, it sends a signal via the copper wiring in the structure. The translation module 208 receives this signal and interprets it as a signal associated with a door sensor. For example, when the sensor is initially attached to the apparatus 100, an operator may configure the apparatus to understand that the attached sensor is a door sensor. Alternatively, the sensor may communicate sufficient information itself to inform the apparatus 100 that the sensor is a door sensor. The translation module 208, recognizing a door sensor event, translates this event into an appropriate API call to a home automation service.

Pre-existing and pre-wired sensors throughout the structure are generally in one of three categories: (1) binary sensors; (2) actuators; and (3) digital inputs. Binary sensors are sensors that report a binary condition, and are typically used for door or window sensors. The apparatus 100 monitors the continuity of an electrical circuit, typically through a reed switch such as those found in a magnetic door/window sensor, motion detector, or the like. The translation module 208 translates the change in state (open/closed) of the circuit to an appropriate API call to the home automation system. For example, the translation module 208 may send the following API call to indicate that a particular device has entered a different state, namely state 1 as opposed to state 0:

PUT/api/konnected/<device id>{“pin”: 5, “state”:1}

This would indicate that pin 5, which corresponds to a “front door” sensor, is open. The translation module 208 makes this call to a home automation service via the communication module 106. In a preferred embodiment, integration software runs on a corresponding home automation platform. This integration software in combination with the home automation platform stores the association between the corresponding device ids and the particular sensors. This integration software receives the API call, and knows that the particular device id (5) is the “front door” and that a state of “1” means the front door is open.

In the case of an actuator, the translation module 208 receives a trigger from the home automation service and translates that to an appropriate electrical signal to actuate electrical devices physically attached to the apparatus 100, such as a siren, strobe light, or relay switch. In a preferred embodiment, the translation module 208 runs an embedded HTTP server and receives an HTTP request from the home automation controller instructing the apparatus to “set state on pin 4 to 1.” Upon receipt of this instruction the processor 200 will apply an electrical current to the appropriate pin.

In the case of digital inputs, the translation module 208 takes digital input from devices such as temperature/humidity sensors and converts them to API calls to the home automation system.

The communication module 106 is used for providing communication between the apparatus and the home automation system 306. The communication module 106 may be a wifi module, a cellular telephony module, or any other module for providing communication. While depicted in the figures as separate logical components, preferably the communication module 106 is integrated with the processor 200 in a single chip. One preferred embodiment currently uses the ESP8266 ESP12 wifi chip.

Although this disclosure has been described in terms of certain embodiments and generally associated methods, alterations and permutations of these embodiments and methods will be apparent to those skilled in the art. Accordingly, the above description of example embodiments does not constrain this disclosure. Other changes, substitutions, and alterations are also possible without departing from the spirit and scope of this disclosure.

What is claimed is:

1. An apparatus for retrofitting a hard-wired building alarm system, the apparatus comprising:
a processor comprising a communications module and a translation module;
a power supply connected to a plurality of power out terminals, wherein a power out terminal is connected to powered building security device using the hard-wired building alarm system wiring; and
a plurality of input/output terminals, wherein an input/output terminal is connected to a building security sensor using the hard-wired building alarm system wiring;
wherein the processor is configured to:
receive sensor data input from an input/output terminal;
translate the sensor data input into home automation output; and
transmit the home automation output to a home automation server using the communication module;
wherein the processor is further configured to:
receive an actuator instruction from the home automation server via the communication module;
translate the actuator instruction into an electrical current on an input/output terminal.

2. An apparatus for integrating a wired building alarm system with a home automation system, the apparatus comprising:
a security-system connector, wherein the security-system connector is connected to a security-system component via the wire in the building; and
a processor, wherein the processor is communicatively connected with the security-system connector and the home automation system, wherein the processor is configured to exchange signals between the security-system connector and the home automation system.

3. The apparatus of claim 2 further comprising:
A communication module, wherein the communication module is communicatively connected with the processor.

4. The apparatus of claim 3 wherein the communication module comprises a network interface.

5. The apparatus of claim 3 wherein the communication module comprises a wireless communication chip.

6. The apparatus of claim 2 wherein the security-system connector is a sensor pin.

7. The apparatus of claim 2 wherein the security-system component is an entry sensor.

8. The apparatus of claim 2 wherein the security-system component is a glass-break sensor.

9. The apparatus of claim 2 wherein the security-system connector is a powered connector.

10. The apparatus of claim 2 wherein the security system component is a siren.

11. The apparatus of claim 2 wherein the security system component is a light.

12. The apparatus of claim 2 wherein exchanging signals between the security-system connector and the home automation system comprises:
the processor receiving a signal via an input/output terminal that the state on a sensor has changed; and
the processor sending the state change information to home automation system.

13. The apparatus of claim 2 wherein exchanging signals between the security-system connector and the home automation system comprises:
the processor receiving an instruction from the home automation system; and
the processor sending an electrical current to an input/output terminal.
